(19) United States
(12) Patent Application Publication
(10) Pub. No.: US 2010/0034175 A1
(43) Pub. Date: Feb. 11, 2010

(54) METHOD OF MANAGING RADIO RESOURCES ON CELL PATTERNS

(76) Inventors: Lie Xiao, Beijing (CN); Jiuhui Du, Solna (SE)

Correspondence Address: ERICSSON INC., 6300 LEGACY DRIVE, M/S EVR 1-C-11, PLANO, TX, 75024, US

(21) Appl. No.: 12/527,528

(22) PCT Filed: Feb. 15, 2007
(86) PCT No.: PCT/SE07/50090

§ 371 Date: Aug. 17, 2009

(51) Int. Cl. H04B 7/216

(52) U.S. Cl. 370/335

(57) ABSTRACT

In a method and system, the controller unit of a cellular radio system is fed with information relating to the cell pattern and the location of subscribers. The controller unit can use such information to improve radio resource algorithms and thereby generate a better evaluation and allocation on radio resources aiming at decreasing the interference in the air-interface and at generating more accurate handover decision so that the performance of the overall network is improved.

### TECHNICAL FIELD

The present invention relates to a method and a device for managing radio resources.

### BACKGROUND

In conventional radio systems, like Global System for Mobile communications (GSM). Wideband Code Division Multiple Access (WCDMA) and Time Division-Synchronous Code Division Multiple Access (TD-SCDMA), a controller unit such as the BSC, (Base Station Controller) for a GSM radio system or the RNC (Radio Network Controller) for a WCDMA radio system is charged Faith the task of controlling the Node-Bs (Base stations) associated therewith including, but not limited to RRM (Radio Resource Management) schemes such as Power Control. Admission Control, Resource Allocation, Handover Control, etc.

Furthermore, for the network planning of radio systems like the Global System for Mobile communications (GSM), Wideband Code Division Multiple Access (WCDMA) and Time Division-Synchronous Code Division Multiple Access (TD-SCDMA), typically, the cell pattern control is very limited and there is typically no accurate way to control it.

In some radio systems such as for example a TD-SCDMA system, smart antenna technology is used. With a smart antenna, the cell pattern is dominantly decided by beam-formed antenna diagram for broadcast channel. In such a system the RNC can control/adjust the beam forming weights for broadcast channel in order to control/adjust cell pattern with also other relevant information like antenna type, tilt, sectorization, antenna installed/placed direction.

However, there is a constant demand to improve the performance of existing as well as future radio networks in order to make use of the radio systems as efficiently as possible. Hence there is a need to improve the link-budget, save power consumption, and remove unnecessary interference to the extent possible.

Hence, there exist a need for a method and a system that is able to reduce the overall power consumption, reduce interference and improve the link-budget over existing systems.

### SUMMARY

It is an object of the present invention to overcome or at least reduce some of the problems associated with the existing radio systems.

It is another object of the present invention to provide a method and a device that enables the RNC to utilize cell pattern information to improve the RRM algorithms.

These objects and others are obtained by the method and system as set out in the appended claims. Thus, by feeding the RNC with information relating to the cell pattern and the location of subscribers such as GPS positioning or AoA (Angle of Arrival) reported periodically by Node-B, the RNC can use such information to improve the current RRM algorithm thereby generate a better evaluation and allocation on radio resources aiming at decreasing the interference in the air-interface and at generating more accurate handover decision so that the performance of the overall network is improved.

Each NodeB site has its own characteristics, especially from network planning points of view. For example, in one direction there are many high buildings but pretty flat in another direction. In such a scenario an irregular cell pattern with bigger beam forming lobe in this high-building direction could be preferred. In another scenario it might be that a new cell is required only, to serve the users in a new highway without big disturbance on original network then a spindly cell pattern only covering the highway might be preferred. By submitting this information to the control unit such as the RNC, the RR-4 algorithm can utilize all such information to improve the planning of the link-budget, reduce power consumption, remove unnecessary interference and so on.

When the RNC is fed with the cell pattern related information, it is possible to enhance the radio resource handling capability of RNC, in particular when AoA (Angle of Arrival) of admitted users is available and mostly there is a LOS (Line Of Sight) between users and their serving Node-B. Hence, the cell pattern could be utilized as reference knowledge during RNC control of Node-Bs Admission control. Resource allocation and Handover control functions.

For example, when a UE trigger a Random Access procedure, the Node-B will notify its associated RNC to execute an Admission control function, in accordance with a RRM scheme, the RNC can use the AoA to decide whether to admit this access request or not based on the network load of its serving Node-B, its generated interference to the users in the same cell and adjacent cells and possibly other parameters.

If cell pattern and AoA information is known for RNC. Radio Access algorithms could assign a different timeslot carrier in order to insulate the users near the edge of sector and cell, otherwise these users may generate undesired inter-sector or inter-cell interference.

If cell pattern and AoA information is known for RNC, it is helpful to optimize the handover control algorithm. If there is LOS between Node-B and its serving users, RNC will know the handovering user is closing to which sector of a cell or to which other cell.

### BRIEF DESCRIPTION OF THE DRAWINGS

The present invention will now be described in more detail by way of non-limiting examples and with reference to the accompanying drawings, in which:

FIG. 1 is a general view of a radio system, and

FIG. 2 is a flowchart illustrating steps performed when feeding cell pattern information to a control unit of a radio system.

### DETAILED DESCRIPTION

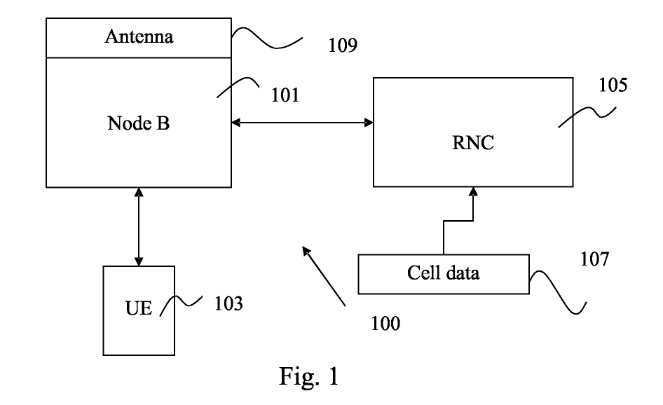

In FIG. 1 a general view illustrating a radio system 100 is depicted. The system 100 comprises a base station (Node B) 101. The base station 101 serves a number of mobile terminals, sometimes termed User Equipment (UE) 103, located within the area covered by the base station 101. The base station 101 is also connected to a controller unit, such as a radio network controller node (RNC), 105. The RNC and the NodeB can communicate with each other for example over an lub logical interface. The RNC 105 is connected to a management system 107 collecting and storing information relating to the cells and the cell patterns of the cells that the unit 105 is controlling. Furthermore, the base station 101 also comprises an air interface, typically an antenna 109 that can be controlled by the unit 105.

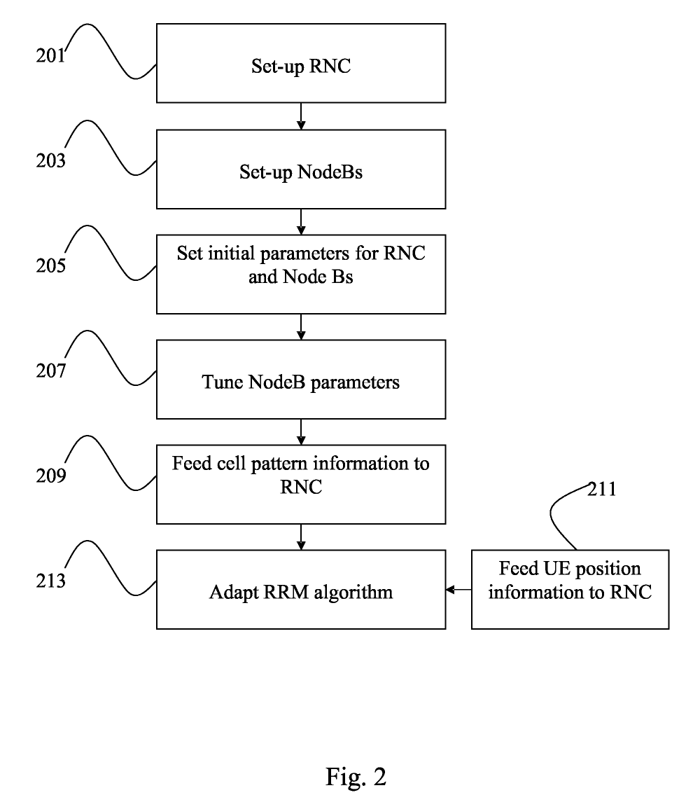

In FIG. 2 a flow chart illustrating different steps performed when setting up a control unit to perform RRM taking into account cell pattern information. Thus, first in a step 201 the RNC 105 is set-up. Next in a step 203 all NodeBs 101 controlled by the RNC 105 are set-up. Thereupon, in a step 205, the system 107 sets initial parameters for the RNC and the Node B. The system 107 can for example be the Operations and Support System for Radio and Core Network (OSS-RC) provided by Ericsson. The parameters are then tuned at each NodeB 101 to provide an overall coverage of the area controlled by the RNC 105, step 207. Next in a step 209, the RNC is fed with information relating to the cell pattern from the system 107. In parallel with the information feed taking place in step 209, the RNC may also be provided with information relating to positions of UEs within the respective cells of the area covered by the cells belonging to the RNC, in a step 211. The positioning information provided in step 211 may be a location established through GPS or some other suitable positioning method such as AoA (Angle of Arrival) provided by the respective NodeBs. Finally in a step 213, the RNC adapts the RRM algorithm in response to the information received in steps 209 and 211 in order to optimize the overall system performance.

By feeding the RNC with information relating to the cell pattern and the location of subscribers such as GPS positioning or AoA (Angle of Arrival) reported periodically by Node-B, the RNC can improve the RRM algorithm and thereby optimizing the radio resources, which will decrease the interference in air-interface and at generating more accurate handover decision. Other decisions that can be improved by access to such information include Admission control and Resource allocation.

For example, because each NodeB site has its own characteristics, especially from network planning points of view, there may many high building in a particular but pretty flat in another direction. In such a scenario, the RNC may recognize that it is advantageous to set up the NodeB with an irregular cell pattern with bigger lobe in this high-building direction and control the NodeB accordingly. In another scenario it might be that a new cell is required only to serve the users in a new highway without big disturbance on original network then a spindly cell pattern only covering the highway might be preferred. By submitting this information to the control unit such as the RNC, the RRM algorithm can utilize all such information to improve the planning of the link-budget, reduce power consumption and remove unnecessary interference.

For example, when a UE trigger a Random Access procedure and then Node-B will notify its associated RNC to execute an Admission control function, in accordance with a RRM schemes, in order to decide to admit this access request or not based oil the network load of its serving Node-B, its generated interference to the users in the same cell and adjacent cells and possibly other parameters.

Furthermore, there is an intra-cell and inter-cell interference estimation process. The conditional calculation is based on the assumption of uplink uniform interference distribution and downlink omni directional transmission. If cell pattern is known for RNC while beam forming is used for Node-Bs. UE could measure and report RNC downlink directional interference. And then. Admission control function can use this knowledge to make an advanced judgment because compare with omni directional interference the directional interference is exacter as a reference forecast for the downlink beam-formed dedicate channel.

If cell pattern and AoA information is known for RNC in a TD-SCDMA system, which use FDMA. TDMA and CDMA, Radio Access algorithms could integrate Resource Allocation algorithm assign a different timeslot for a carrier in order to insulate the users near the edge of sector and cell, otherwise these users may generate a undesired inter-sector or inter-cell interference.

In accordance with another embodiment of the present invention, the RNC provided with cell pattern information and UE position information can be used to set frequency and slot priority to each cell in a TD-SCDMA system. For example, if a network access request comes from a user located at the cell border the NodeB will try to access this user with priority radio resources, if it comes from a user located at the cell center, radio resources without high priority can be assigned. By assigning radio resources in such a manner, the inter-cell interference is handled in a resource efficient way.

Finally, if cell pattern and AoA information is known for RNC. it will generate a better handover control algorithm. because the RNC will then know which sector or cell the user is getting close to. This can for example be accomplished by forming a priority handover cell list in order to reduce handover related measurements and reduce handover time delay and so on. For example, for a first UE located in a first cell (CELL1) at the border of a second cell (CELL2), CELL2 will be set as the first handover cell in the cell list. i.e. the cell with highest priority. For a second UE also located in the first cell (CELL1) but at the border of a third cell (CELL3), the third cell (CELL3) will be set as the cell with the highest priority in the cell list maintained by the RNC for each UE of each cell.

The cell list can comprises more than one candidate cell for each UE ranking the candidate cells for handover from the cell with highest priority down to the least preferred cell to hand over to. Also the same procedure can be used for intra cell activities when a UE travels from one sector of a cell towards another sector of the same cell. In this manner and using some detailed parameter setting like handover trigger conditions, handover success rate will be enhanced and time delay will be decreased because handover measurements and procedures are made obsolete.

1. A method of controlling radio resources in a cellular radio system network, the radio systems network comprising a number of base stations controlled by a controller unit, comprising the steps of:
feeding the controller unit with information relating to cell patterns of the cellular radio system; and,
controlling the radio resources in response to the information relating to the cell patterns.

2. The method according to claim 1, further comprising the steps of:
feeding the controller unit with information relating to the location of mobile stations located in the cellular system network; and,
controlling the radio resources in response to the information relating to the location information.

3. The method according to claim 2, wherein the location information is a position established by a Global Positioning System (GPS).

4. The method according to claim 2, wherein the location information is a position established by Angle of Arrival (AoA).

5. The method according to claim 1, further comprising the step of controlling a transmitted lobe pattern of the base stations in response to the information relating to the cell patterns or the location of mobile stations in the cellular radio system.

6. The method according to claim 1, by further comprising the step of controlling admission of new mobile stations in a particular cell based on information relating to the cell pattern of the system or the location of mobile stations in the cellular radio system.

7. The method according to claim 1, wherein the system is a time division system, further comprising the step of assigning time slots based on information relating to the cell pattern of the system and/or or the location of mobile stations in the cellular radio system.

8. The method according to claim 1, further comprising the step of performing handover based on information relating to the cell pattern of the system or the location of mobile stations in the cellular radio system.

9. The method according to claim 8, further comprising the step of maintaining a list for each a mobile station in the cellular radio system comprising at least one entry indicating the most preferred cell to handover to.

10. The method according to claim 9, wherein the list comprises more than one entry and the entries other than the first comprises other candidate cells in priority order.

11. A controlling unit for controlling radio resources in a cellular radio system network, comprising:
means for receiving information relating to cell patterns of the cellular radio system, and,
means for controlling the radio resources in response to the information relating to the cell patterns.

12. The unit according to claim 11, further comprising:
means for feeding receiving information relating to the location of mobile stations located in the cellular system network, and,
means for controlling the radio resources in response to the information relating to the location information.

13. The unit according to claim 12, wherein the location information is a position established by a Global Positioning System (GPS).

14. The unit according to claim 12, wherein the location information is a position established by Angle of Arrival (AoA).

15. The unit according to claim 11 further comprising means for controlling a transmitted lobe pattern of base stations in the cellular radio system in response to the information relating to the cell patterns or the location of mobile stations in the cellular radio system.

16. The unit according to claim 11, further comprising means for controlling admission of new mobile stations in a particular cell based on information relating to the cell pattern of the system or the location of mobile stations in the cellular radio system.

17. The unit according to claim 11, wherein the system is a time division system, further comprising means for assigning time slots based on information relating to the cell pattern of the system or the location of mobile stations in the cellular radio system.

18. The unit according to claim 11, further comprising means for performing handover based on information relating to the cell pattern of the system an or the location of mobile stations in the cellular radio system.

19. The unit according to claim 18, further comprising means for maintaining a list for each a mobile station in the cellular radio system comprising at least one entry indicating the most preferred cell to handover to.

20. The unit according to claim 19, wherein the list comprises more than one entry and the entries other than the first comprises other candidate cells in priority order.
